(19) United States
(12) Patent Application Publication
(10) Pub. No.: US 2024/0081568 A1
(43) Pub. Date: Mar. 14, 2024

(54) SLIDE MAT FOR PROTECTING KITCHEN SURFACES

(71) Applicant: Linda Young, Swedesboro, NJ (US)

(72) Inventor: Linda Young, Swedesboro, NJ (US)

(21) Appl. No.: 17/942,141

(22) Filed: Sep. 11, 2022

(51) Int. Cl. A47G 27/02

(52) U.S. Cl. CPC A47G 27/0212; A47G 27/0206

(57) ABSTRACT

A slide mat is presented. The slide mat is a thin and stylish protective support upon which a heavy and/or large kitchen countertop appliance such as a stand mixer are set upon, particularly a surface such as a countertop. The mat allows the appliance to be moved, or slid, over a surface with a minimum of physical effort. The mat is placed upon a surface of any type of material including but not limited to: stone, granite, quartz, synthetic material, laminated composite, wood, polished concrete, or the like. The use of the mat upon any specific type of surface is not intended to be a limiting factor of the present invention.

### FIELD OF THE INVENTION

This invention relates to mats. More particularly, it relates to a slide mat for protecting kitchen surfaces.

### BACKGROUND

A kitchen is a place in a house for cooking and sometimes for eating. Kitchens often time have cabinets which have a surface, or countertop, that can provide prep space for cooking, storage of appliances, etc.

A countertop, also countertop, counter, benchtop, worktop, kitchen bench, bunker is a raised, firm, flat, and horizontal surface. They are built for work in kitchens or other food preparation areas, bathrooms or lavatories, and workrooms in general. The surface is frequently installed upon and supported by cabinets, positioned at an ergonomic height for the user and the particular task for which it is designed. A countertop may be constructed of various materials with different attributes of functionality, durability and aesthetics, and may have built-in appliances, or accessory items relative to the intended application.

The common fitted Western-style kitchen, developed in the early 20th century, is typically an arrangement of assembled unit cabinetry covered with a more-or-less continuous countertop work surface. Primary considerations of material choice and conformation are durability, functionality, hygienics, appearance, and cost.

When installed in a kitchen on standard wall-mounted base unit cabinets, countertops are typically about 25-26 inches (635-660 mm) from front to back and are designed with a slight overhang on the front (leading) edge. This allows for a convenient reach to objects at the back of the countertop while protecting the base cabinet faces. It can also act as kick space that may not have been provided at the floor, allowing a person to stand closer to the countertop, improving ergonomics. Finished heights from the floor will vary depending on usage but typically will be 35-36″ (889-914 mm), with a material thickness depending on that chosen. They may include an integrated or applied backsplash to prevent spills and objects from falling behind the cabinets. Kitchen countertops may also be installed on freestanding islands, dining areas or bars, desk and table tops, and other specialized task areas; as before, they may incorporate cantilevers, free spans and overhangs depending on application. The horizontal surface and vertical edges of the countertop can be decorated in manners ranging from plain to very elaborate. They are often conformed to accommodate the installation of sinks, stoves, ranges, and cooktops, or other accessories such as dispensers, integrated drain boards, and cutting boards.

One of a problem with place items, such as appliances, on a countertop in a kitchen is that the movement of the appliance can cause damage to the surface of the countertop. Furthermore, any spillage from an appliance can mar r cause slickness and other types of accidents in the kitchen.

Accordingly, and in light of the foregoing, it would be desirable to have a device for an appliance or other product be placed on that will protect the countertop from being damaged and others from avoidable kitchen accidents. It would be further advantageous if the device were easily usable, reusable, cost effective and decorative.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the slide mat 10, according to the preferred embodiment of the present invention;

FIG. 2 is a top view of the slide mat 10, according to the preferred embodiment of the present invention;

FIG. 3 is an exploded layer view of the slide mat 10, according to the preferred embodiment of the present invention;

FIG. 4 is a side view of the slide mat 10, according to the preferred embodiment of the present invention;

FIG. 5 is a sectional view of the slide mat 10, as seen along a line I-I, as shown in FIG. 2, according to the preferred embodiment of the present invention; and,

FIG. 6 is a perspective view of the slide mat 10, shown in a utilized state with a countertop appliance 55, according to the preferred embodiment of the present invention.

### DESCRIPTIVE KEY

10 slide mat
15 surface
20 rounded edge
25 upper textile surface
30 border stitching
35 embroidery stitching
40 upper batting layer
45 lower batting layer
50 lower textile surface
55 appliance
60 perimeter border “b”
65 travel path “t”

### DESCRIPTION OF THE PREFERRED EMBODIMENTS

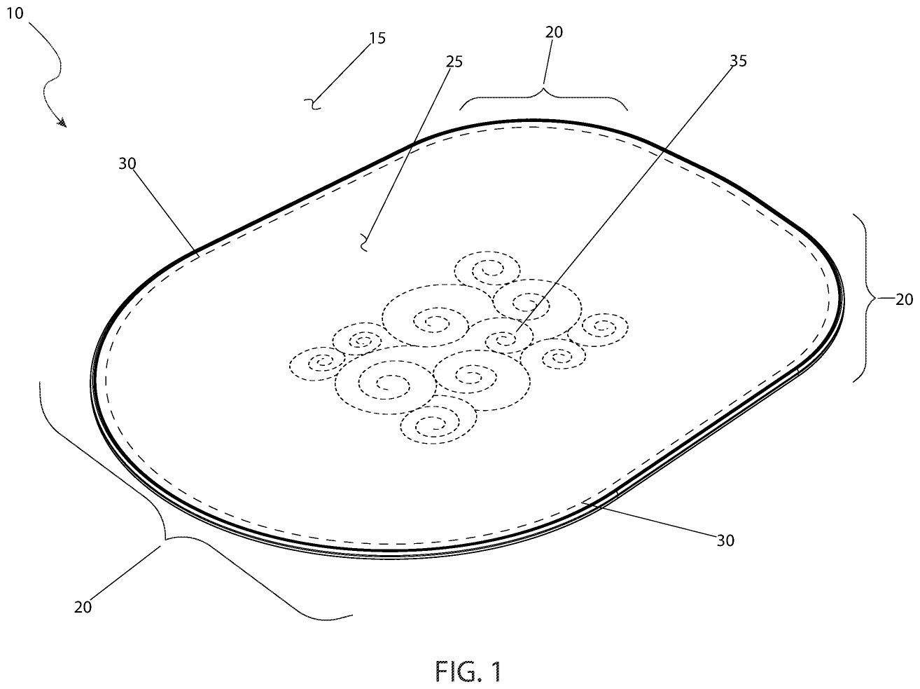

The best mode for carrying out the invention is presented in terms of its preferred embodiment, herein depicted within FIGS. 1 through 6. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. DETAILED DESCRIPTION OF THE FIGURES

Referring now to FIG. 1, a perspective view of the slide mat 10, according to the preferred embodiment of the present invention is disclosed. The slide mat (herein also described as the “mat”) 10, is a thin and stylish protective support upon which a heavy and/or large kitchen countertop appliance 55 such as a stand mixer are set upon, particularly a surface 15 such as a countertop. The mat 10 allows the appliance 55 to be moved, or slid, over a surface 15 with a minimum of physical effort. The mat 10 is placed upon a surface 15 of any type of material including but not limited to: stone, granite, quartz, synthetic material, laminated composite, wood, polished concrete, or the like. The use of the mat 10 upon any specific type of surface 15 is not intended to be a limiting factor of the present invention.

The overall shape of the mat 10 is generally rectangular with rounded edges 20. The overall size of the mat 10 will vary per specific appliance the mat 10 is used with. However, a typical size will be approximately eighteen inches (18 in.) in depth, and thirteen inches (13 in.) in width for a typical appliance 55. The exact size and shape of the mat 10 is not intended to be a limiting factor of the present invention. The mat 10 comprises an upper textile surface 25 envisioned to be made of one hundred percent (100%) cotton fabric. Further description on the construction of the mat 10 will be provided herein below. Border stitching 30 is located about the perimeter of the mat 10. Embroidery stitching 35 is located in the interior center area of the mat 10.

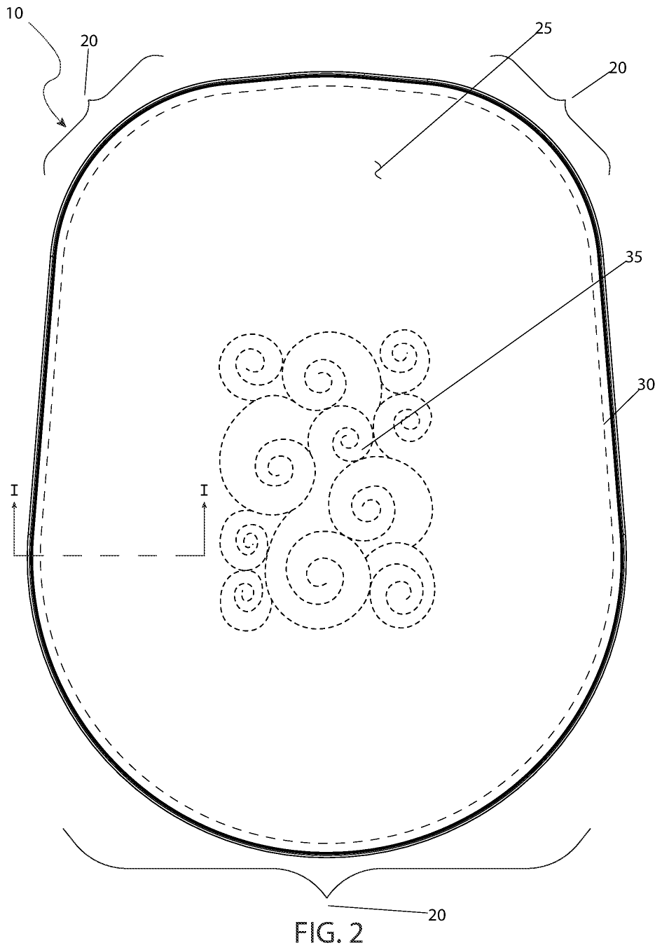

Referring next to FIG. 2, a top view of the mat 10, according to the preferred embodiment of the present invention is depicted. This view provides further clarification of the upper textile surface 25 with the rounded edges 20 and the embroidery stitching 35 providing an internal binding force. It is envisioned that the embroidery stitching 35 would have a typical size of five inches by seven inches (5-7 in.) for a typical sized mat 10. The physical size of the embroidery stitching 35 is not intended to be a limiting factor of the present invention. The upper textile surface 25 may be provided with decorative indicia such as patterns, logos, caricatures, cartoons, diagrams, pictures of the like. The border stitching 30 is set back approximately three/sixteenths of an inch ( 3/16 in.) from the exterior border of the mat 10.

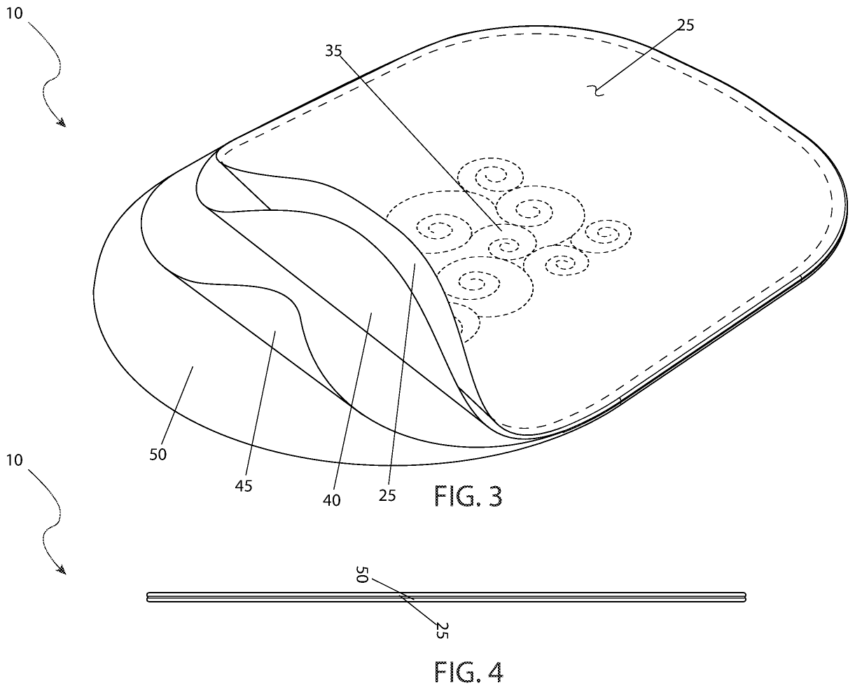

Referring now to FIG. 3, an exploded layer view of the mat 10, according to the preferred embodiment of the present invention is shown. This view provides additional clarification of the internal construction of the mat 10. The upper textile surface 25 is shown in a “peeled” back, or partially disassembled state, on the front of the mat 10. Directly below the upper textile surface 25 is an upper batting layer 40. A lower batting layer 45 is then located below the upper batting layer 40 and on top of a lower textile surface 50. The upper batting layer 40 and the lower batting layer 45 are envisioned to be made of cotton/polycotton batting material, and provides a cushioning effect to the mat 10, that produces a quilted appearance that is not only aesthetically pleasing but provides for easier sliding upon the surface 15 (as shown in FIG. 1), even while supporting an appliance 55. The lower textile surface 50 is envisioned to be made of one hundred percent (100%) cotton fabric. The lower textile surface 50 provides a low coefficient of friction to further enable easy sliding. The embroidery stitching 35 serves to provide a stabilizing force to the upper textile surface 25, the upper batting layer 40, the lower batting layer 45, and the lower textile surface 50, by binding them together along with the border stitching 30 (as shown in FIGS. 1 and 2) to prevent delamination of the layers, especially when machine washing, and keeps said layers, stable and flat.

Referring next to FIG. 4, a side view of the mat 10, according to the preferred embodiment of the present invention is disclosed. This view provides clarification of the upper textile surface 25 and the lower textile surface 50. The side view as depicted in FIG. 4 would be typical from all sides of the mat 10. The upper textile surface 25 and the lower textile surface 50 are held in physical contact with each other via the border stitching 30 (as shown in FIGS. 1 and 2). It is noted that the upper batting layer 40 and the lower batting layer 45 are not visible from the exterior of the mat 10.

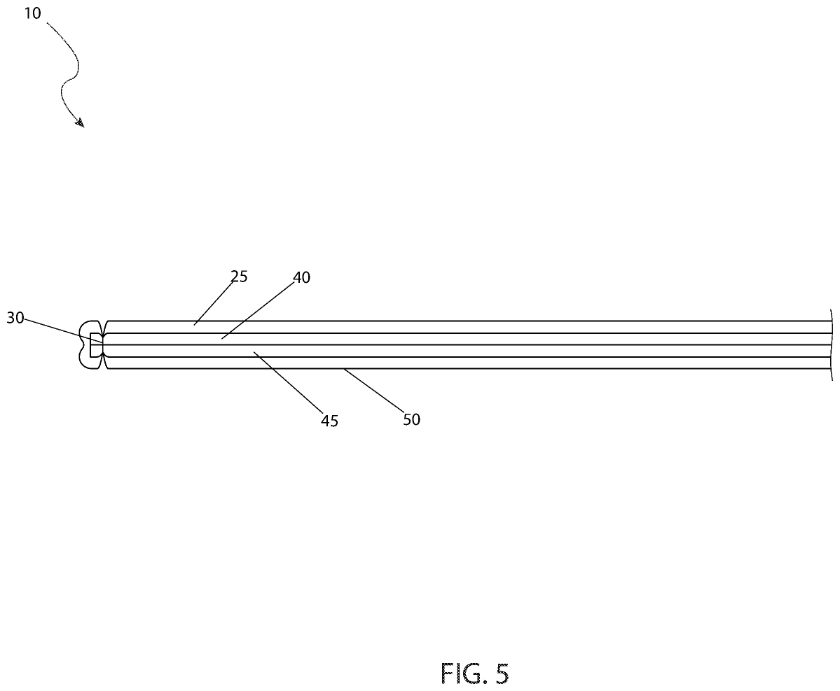

Referring now to FIG. 5, a sectional view of the mat 10, as seen along a line I-I, as shown in FIG. 2, according to the preferred embodiment of the present invention is depicted. As previously described, the upper textile surface 25 (top) and the lower textile surface 50 (bottom) sandwich the upper batting layer 40 and the lower batting layer 45. In its fully assembled state, the mat 10 is approximately one-eighth to one-quarter of an inch (⅛-¼ in.) in total thickness (height), depending on the compression of the upper batting layer 40 and lower batting layer 45. The border stitching 30 secures the upper textile surface 25 and the lower textile surface 50 together while retaining the upper batting layer 40 and the lower batting layer 45 on the interior. It is noted that the embroidery stitching 35 (as shown in FIGS. 1 and 2) operate in a similar securing manner as the border stitching 30 to aid in overall shape retention of the mat 10 and prevent “bunching” and “clumping” of the upper batting layer 40 and the lower batting layer 45.

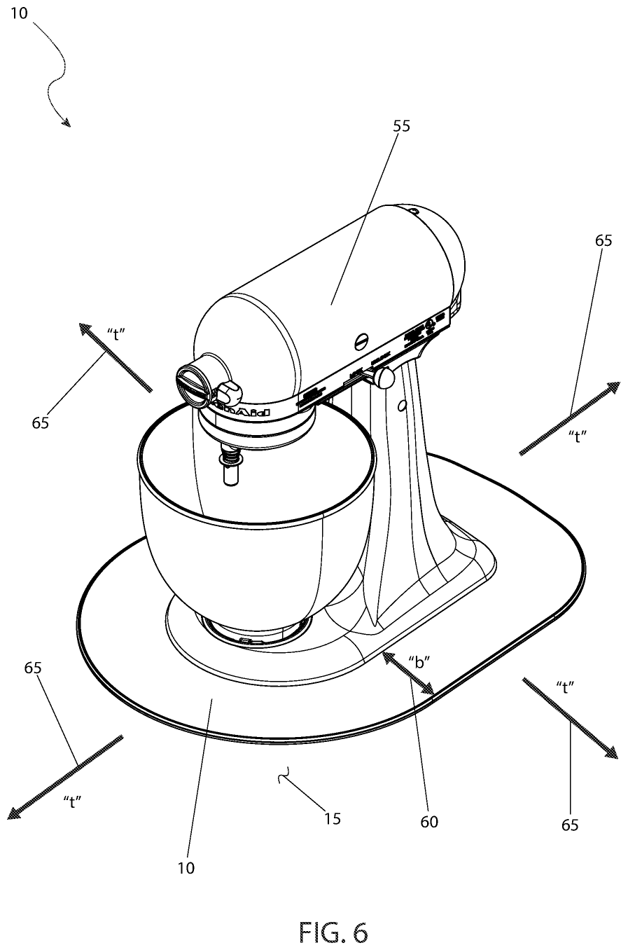

Referring finally to FIG. 6, a perspective view of the mat 10, shown in a utilized state with a countertop appliance 55, according to the preferred embodiment of the present invention is shown. The appliance 55 is depicted as a stand mixer for purposes of illustration, due to its large size, weight, and difficulty in moving it upon a surface 15. However, other large countertop appliances 55 such as blenders, toaster ovens, crockpots, air fryers, and the like, may also be used with the teachings of the present invention. The placement of the appliance 55 upon the mat 10 yields a of several inches (ranging from one inch to four inches (1-4 in.)), to form an aesthetically appealing appearance and provide a gripping area to slide the mat 10. By pushing or pulling the surface 15 and/or the mat 10, the user may move the mat 10 and the appliance 55 along a 360-degree(360°) travel path “t” 65 upon the surface 15. In such a manner, the user is afforded ease and comfort when using the appliance 55 at various locations on the surface 15 by simply sliding the mat 10 with the appliance 55 supported thereon into place, rather that lifting it and putting it back down.

### 2. Operation of the Preferred Embodiment

The preferred embodiment of the present invention can be utilized by the common user in a simple and effortless manner with little or no training. It is envisioned that the mat 10 would be constructed in general accordance with FIG. 1 through FIG. 6. The user would procure the mat 10 from conventional procurement channels such as retailers, discount stores, department stores, mail order and internet supply houses and the like. Special attention would be paid to any specific size and shape of the mat 10 to work with the intended appliance 55. Additionally, the user may select the appearance of the upper textile surface 25, the lower textile surface 50 and the pattern of the embroidery stitching 35. After procurement and prior to utilization, the mat 10 would be prepared in the following manner: the mat 10 would be placed upon the surface 15 with the lower textile surface 50 in contact with the surface 15; the appliance 55 would initially be placed on the mat 10 such that it is centered and provides a symmetrical spacing of the perimeter border “b” 60 on all opposite sides. At this point in time, the mat 10 is ready for utilization.

During utilization of the mat 10, the following procedure would be initiated: should the location of the appliance 55 on the surface 15 need to be relocated, either for purposes of use, cleaning, maintenance or the like, the user would supply a pushing or pulling force to the appliance 55 and/or the mat 10 about the travel path “t” 65 to reposition the appliance 55. It is envisioned that the amount of force necessary would be much less that sliding the appliance 55 without the mat 10, or even lifting the appliance 55 and repositioning it. As such, the use of the mat 10 is ideal for a single person use who may be elderly, suffering from a disability, recovering from surgery, or just of diminished strength. Such ability to move an appliance 55 on one's own restores independence and feelings of self-sufficiency. It is envisioned that the appliance 55 may be removed from the mat 10, allowing it to be periodically machine washed and dried, allowing it to be replaced and reused following the general usage pattern as described above.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A slide mat for providing a protective support for a large kitchen appliance on a surface, the slide mat comprising:
an upper textile surface;
an upper batting layer, the upper batting layer coupled to the upper textile surface;
a lower batting layer, the lower batting layer coupled to the upper batting layer; and
a lower textile surface, the lower textile surface coupled to the lower batting surface, wherein the slide mat having a border stitching.

2. The slide mat according to claim 1, wherein the slide mat having a generally rectangular shape, the shape having rounded edges.

3. The slide mat according to claim 2, wherein the shape having rounded edges.

4. The slide mat according to claim 1, wherein the slide mat has a depth of eighteen inches.

5. The slide mat according to claim 1, wherein the slide mat has width of thirteen inches.

6. The slide mat according to claim 1, wherein the upper textile surface is made of a one-hundred percent cotton fabric.

7. The slide mat according to claim 1, wherein the slide mat has an embroidery stitching configured at an interior center area of the mat.

8. The slide mat according to claim 7, wherein the embroidery stitching has a size of between five and seven inches.

9. The slide mat according to claim 1, wherein the upper textile surface has a decorative indicium.

10. The slide mat according to claim 9, wherein the decorative indicium being a pattern.

11. The slide mat according to claim 9, wherein the decorative indicium being one or more logos.

12. The slide mat according to claim 9, wherein the decorative indicium being a caricature.

13. The slide mat according to claim 9, wherein the decorative indicium being a diagram.

14. The slide mat according to claim 9, wherein the decorative indicium being a cartoon.

15. The slide mat according to claim 9, wherein the decorative indicium being a picture.

16. The slide mat according to claim 1, wherein the border stitching having a set back from an exterior border of the slide mat of three sixteenths inch.

17. The slide mat according to claim 1, wherein the lower textile surface being made of a one-hundred percent cotton material.

18. The slide mat according to claim 1, wherein the cotton mater is configured to provide a cushioning effect to the slide mat.

19. The slide mat according to claim 1, wherein the slide mat has a thickness of between one-eighth to one quarter inch.

20. The slide mat according to claim 1, wherein the slide mat is configured to allow an appliance to be placed such that the between one to four inches of the slide mat is accessible to a user for gripping the slide mat to move the appliance.
